(19) United States
(12) Patent Application Publication
(10) Pub. No.: US 2003/0056996 A1
(43) Pub. Date: Mar. 27, 2003

(54) Weight inspection apparatus

(75) Inventor: Atsushi Uchida, Yokkaichi-City (JP)

Correspondence Address: CASELLA & HESPOS, 274 MADISON AVENUE, NEW YORK, NY, 10016

(73) Assignee: Sumitomo Wiring Systems, Ltd., Yokkaichi-City (JP)

(21) Appl. No.: 10/225,340

(22) Filed: Aug. 20, 2002

(30) Foreign Application Priority Data
Sep. 25, 2001 (JP) 2001-291188

(51) Int. Cl. G01G 19/52

(52) U.S. Cl. 177/50

(57) ABSTRACT

A weight inspection apparatus (J) has an electronic balance (13), a comparator (62) for comparing the weight of the article measured with a predetermined reference weight and outputting a difference between the measured weight and the reference weight. Thus, a determination is made whether the article has a possibility of being defective if the difference exceeds the predetermined allowance value. An abnormal signal-receivers (61b) receives an abnormal signal outputted from the injection molding press. When the abnormal signal is received, it is determined that the article formed in an injection molding operation performed in an abnormal state have a possibility of being defective.

### BACKGROUND OF THE INVENTION

1. Field of the Invention

The invention relates to a weight inspection apparatus for measuring the weight of an article formed by injection molding and determining whether the article is defective based on the result of measurement.

2. Description of the Related Art

A phenomenon called a “short shot” may occur while forming a resin article with a molding press due to an insufficient filling of the resin. The short shot occurs where the fused resinous material is not filled completely in a die due to an improper temperature, an improper pressure, and the like or where an air removal hole of the die clogs when the fused resinous material is filled therein. The short shot causes the molded article to have a cutout or the like. There is a variation in the degree of the cutout. Some defective articles have such a slight degree of cutout that they are close to non-defective articles, whereas others have a high degree of cutout.

A phenomenon called “over-packing” also may occur in forming a resin article with an injection molding press due to the influence of pressure or the like. That is, the article is defective because of an extra portion, a thick portion or the like.

It is difficult for the conventional injection molding press to eliminate failure attributable to short shots and over-packing. Even a superior injection molding press produces a short shot once for thousands to tens of thousands of molding operations. Dies for forming some compact articles, like a connector housing of a wire harness, have complicated constructions and many projected pins. Repeated molding operations cause the pins of the die to break. The broken pins may stick to the formed connector housing and cause articles formed by the die to be defective.

Such being the case, whether a molded article is defective is determined by inspection. Manual inspection cannot provide reliable results. Thus, the inspection typically is performed by a weight-measuring apparatus.

The weight inspection apparatus has a weight-measuring means for measuring the weight of a formed article. The conventional apparatus also has a comparison means for comparing a measured weight of the article with a predetermined reference weight and outputting the difference between the measured weight of the article and the predetermined reference weight. A determination means is provided for determining that the article is non-defective if the difference outputted from the comparison means falls within a predetermined allowance value and determining that the article has a possibility of being defective if the difference exceeds the predetermined allowance value. The conventional apparatus further has a separation means for separating a non-defective article and a defective article from each other, according to the result of the determination. The weight-measuring means measures articles formed in one injection molding operation. Whether the article is defective or not is determined based on the operation of the comparison means and the determination means. The separation means separates the formed articles into non-defective ones and defective ones. These operations are performed automatically.

Some dies simultaneously form a plurality of articles that have the same configuration, and frequently there is a variation in the weight of the simultaneously molded articles if the extent of filling the injection-molded resin differs from one article to another. Normally the weight of the article fluctuates in an allowed range. However, an article having a short shot and an article having over-packing may be present simultaneously.

In the conventional weight inspection apparatus, plural articles formed in one operation are assessed for defects by measuring the total weight. In this case, the weight of the article having the short shot may be offset by the weight of the article having the over-packing. Thus these simultaneously formed articles all are determined to be non-defective.

It is known experimentally that the cushioning amount (amount of resin remaining on front end of screw) of the injection molding press and an injection pressure thereof frequently have an abnormal values. However the conventional weight inspection apparatus is not interlocked with the injection molding press. Thus it is impossible to accurately determine whether the article is defective or not.

The present invention has been made to solve the above-described problem. Accordingly, it is an object of the present invention to provide a weight inspection apparatus capable of determining whether an article formed by injection molding is defective or not.

### SUMMARY OF THE INVENTION

The invention is directed to a weight inspection apparatus for determining whether an article formed by injection molding is defective based on the weight of the article. The injection molding of the article is carried out by equipment having a die and an injection molding press that fills a resinous material into the die. The apparatus comprises a weight measuring means for measuring the weight of the article formed in a single injection molding operation performed by the injection molding press. The apparatus also has a comparison means for comparing the weight of the article measured by the weight-measuring means with a predetermined reference weight and outputting a difference between the measured weight of the article and the predetermined reference weight. A determination means is provided for determining that the article is non-defective if the difference outputted from the comparison means falls within a predetermined allowance value and determining that the article has a possibility of being defective if the difference exceeds the predetermined allowance value. The apparatus also comprises an abnormal signal-receiving means for receiving an abnormal signal outputted from the injection molding press. The abnormal signal indicates that the injection molding operation was performed abnormally and that the article has a possibility of being defective.

The abnormal signal is outputted from the injection molding press when the value of to-be-managed items of the injection molding press at an injection molding time are out of a predetermined set of values. The to-be-managed items vary in dependence on a molding machine. But generally, the to-be-managed item include a cushioning amount, an injection pressure, a filling period of time, a cycle period of time, a dwell switching position, a dwell, a screw back pressure, an injection speed, the temperature of a heating cylinder, and the like. A proper range is set for each of these to-be-managed items.

Frequently excess or deficiency of resin supplied to the injection molding press or a rise or reduction of the injection pressure causes a formed article to be defective. Therefore, the abnormal signal-receiving means of the weight inspection apparatus preferably receives the abnormal signal generated from the injection molding press due to excess or deficiency of the cushioning amount or excess or deficiency of the injection pressure.

When the abnormal signal-receiving means has received the abnormal signal, it is determined that the injection molding operation performed abnormally and there is a possibility of at least one article being defective. That is, the determination operation of the weight inspection apparatus is performed in association with the operation of the injection molding press. When the abnormal signal-receiving means has received the abnormal signal, the article has a high possibility of being defective. Thus the state in which the injection molding press has outputted the abnormal signal is detected, and it is possible to determine accurately whether or not the article is defective.

The weight inspection apparatus may include a separation means for separating non-defective articles and defective articles from each other, according to the result of a determination made by the determination means or the result of the reception of the abnormal signal. Accordingly, it is possible to automatically separate the non-defective article and the defective article from each other. Thus an inspector visually checks a comparatively small number of articles determined as being defective and separated from non-defective articles, thus greatly improving operation efficiency.

The abnormal state is likely to continue for some time in the injection molding press after the abnormal signal has been received. Accordingly, articles formed in injection molding operations subsequent to the injection molding operation that was performed in the abnormal state are likely to be defective. According to the present invention, it is determined automatically that articles formed in injection molding operations performed a predetermined number of times subsequent to the injection molding operation performed in the abnormal state have a possibility of being defective. Therefore it is possible to prevent non-defective articles and defective articles from being present in the same place.

Preferably, when the abnormal signal-receiving means has received the abnormal signal, an article formed in the injection molding operation performed in the abnormal state can be separated from the non-defective article by using the separation means.

According to the present invention, it is possible to separate the non-defective article and the defective article from each other. Thus it is possible to improve the yield greatly.

### BRIEF DESCRIPTION OF THE DRAWINGS

FIG. 1 is a schematic view showing a weight inspection apparatus of the present invention, an injection molding press, and a die.

FIG. 2 is a perspective view showing the weight inspection apparatus of the present invention.

FIG. 3 is a front view showing the weight inspection apparatus of the present invention.

FIG. 4 is a perspective view showing an arm-moving/tilting mechanism for moving a receiving plate.

FIG. 5 is a block diagram showing the construction of the periphery of a control part of the weight inspection apparatus of the present invention.

FIGS. 6A through 6D are explanatory views showing the change of a receiving plate which is moved by an arm.

FIG. 7 is a timing chart for explaining the operation of the weight inspection apparatus of the present invention.

FIG. 8 is a timing chart for explaining an operation to be performed in the case where an abnormal signal is successively received.

FIG. 9 is a schematic plan view showing the weight inspection apparatus (another embodiment), an injection molding press, and a die.

### DETAILED DESCRIPTION OF THE PREFERRED EMBODIMENTS

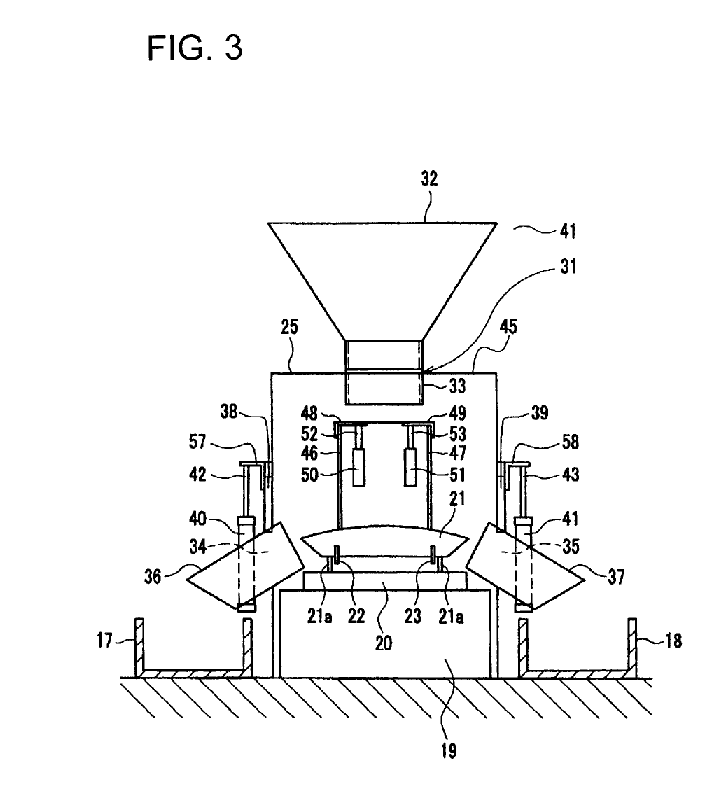

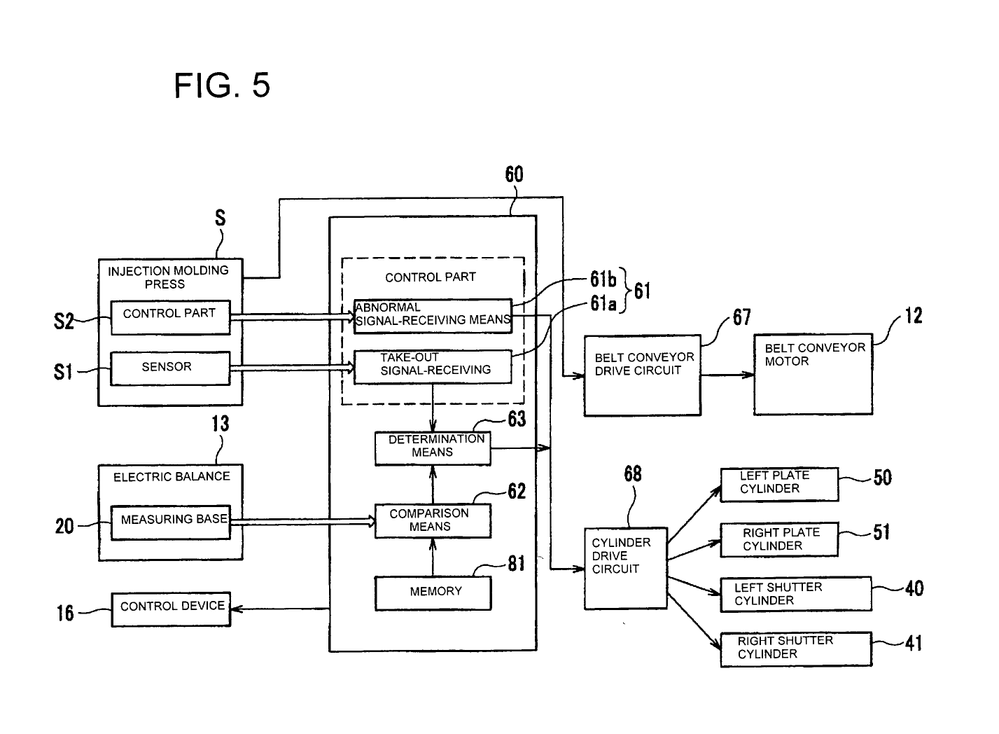

The embodiments of the weight inspection apparatus of the present invention will be described in detail below with reference to the drawings. The right-to-left direction in the following description refers to the right-to-left direction in FIGS. 3 and 5.

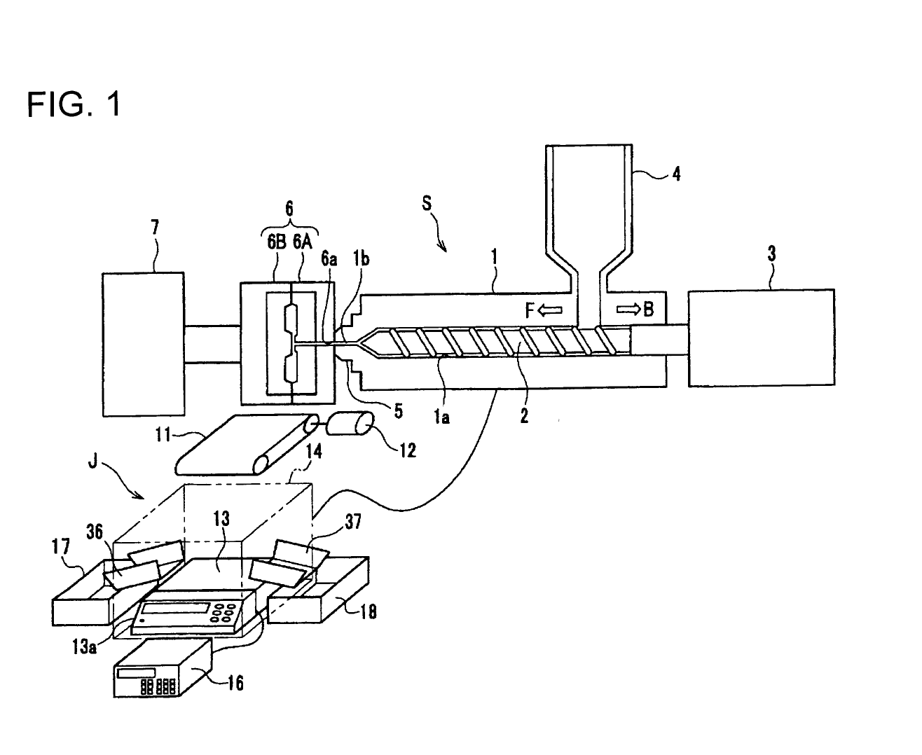

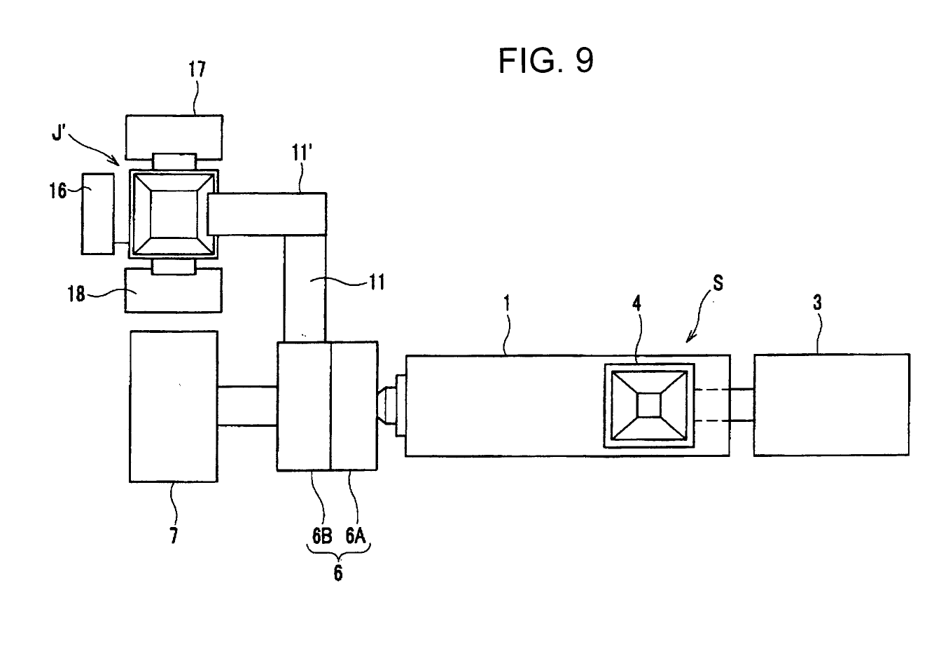

The letter J in FIGS. 1 and 9 identifies a weight inspection apparatus according to the present invention. The weight inspection apparatus J is used with an injection molding press S and a die 6, the operation of which are described briefly below.

The injection molding press S has a heating cylinder 1, a screw 2, an oil motor 3, and a hopper 4, as shown in FIG. 1. The screw 2 is inserted into a hole 1a that extends from a rear end of the heating cylinder 1 to a front end thereof. The oil motor 3 is connected to the rear end of the screw 2. The screw 2 moves to a forward side F and a backward side B due to the operation of the oil motor 3. The hopper 4 is connected to the hole 1a, and is disposed above the rear side of the heating cylinder 1. The hopper 4 accommodates a resinous material (not shown) that can be supplied to the heating cylinder 1.

An injection nozzle 5 is formed at the front end of the heating cylinder 1 and has a reduced diameter injection hole 1b that communicates with the front end of the hole 1a of the heating cylinder 1. The injection nozzle 5 is capable of supplying the resinous material to a sprue 6a of a die 6 for forming an article.

The die 6 has an upper part 6A and a lower part 6B, and is opened and closed by operating an opening/closing device 7.

In this embodiment, the die 6 forms four articles having the same mode in one molding operation. Additionally, the molded article in this embodiment is a housing H for an electrical connector, an optical connector or the like.

The resinous material supplied from the hopper 4 is fed forward by rotating the screw 2 to move toward the back B. As a result, the resinous material is filled into the forward side of the heating cylinder 1 so that the resinous material is heated. The amount of fused resin that is filled in the heating cylinder 1 is determined by an amount of rearward movement of the screw 2 and equals the amount used for one injection.

A slide movement of the screw 2 to the forward side F causes the fused resin in the heating cylinder 1 to be injected from the injection nozzle 5 at the front end of the heating cylinder 1 and fed to the die 6 as part of an injection process. The screw 2 causes the fused resin in the die 6 to dwell, and maintains a specified injection pressure for a predetermined time. The fused resin then is hardened as part of a dwell process. After the resin in the die 6 is hardened, the die 6 is opened by the opening/closing device 7 to take out the housing H made of the hardened resin. Thereafter the die 6 is closed again, as part of a die-opening/closing process, and the injection process starts again.

As described above, the molding of the resin is performed in a series that comprises the injection process, the dwell process, and the die-opening/closing process.

The weight inspection apparatus J of the present invention measures the weight of the formed housing H in association with each of the above-described processes and determines whether the housing H is non-defective or there is a possibility that the housing H is defective. As shown in FIGS. 1 through 5, the weight inspection apparatus J has a feeder, a weight-measurer, and a controller 60.

The feeder has a belt conveyor 11 to feed the housings H from the die 6 to the weight-measurer. The belt conveyor 11 extends substantially horizontally from a location below the die 6 to a location above the weight-measurer. A conveyor motor 12 drives the belt conveyor 11 in association with the operation of the injection molding press S through a belt conveyor-driving circuit 67, described later.

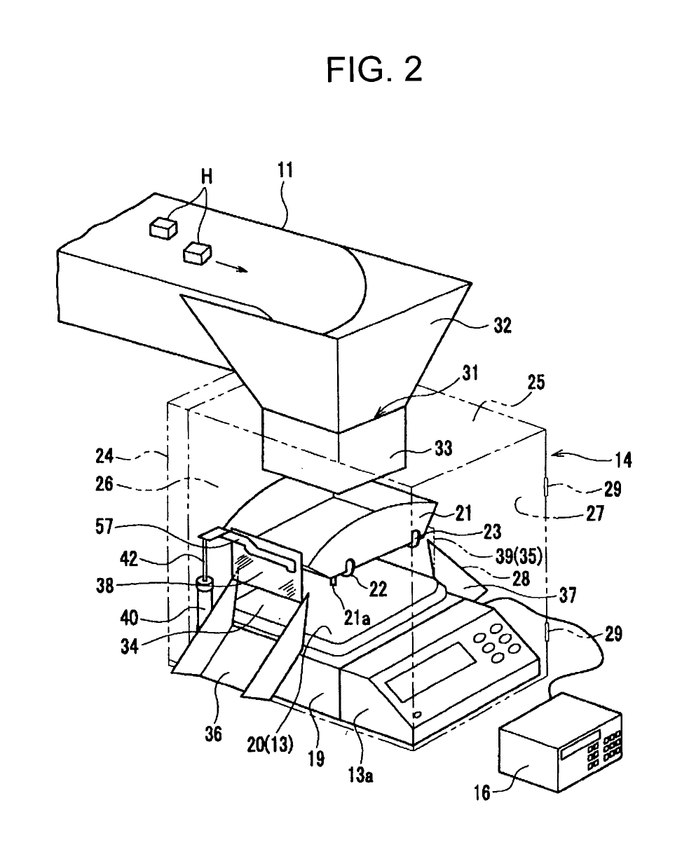

As shown in FIG. 2, the weight-measurer has an electronic balance 13, an accommodation box 14, a separation means, and a control device 16 for executing various setting operations and accommodating a control part 60.

The accommodation box 14 prevents the electronic balance 13 from being vibrated slightly by a side wind or the like. The accommodation box 14 includes an accommodation plate 24 erect at the rear of the electronic balance 13 and a windbreak. The lower part of the accommodation plate 24 is connected with the rear surface of the electronic balance 13 and extends up along the rear surface of the electronic balance 13, thus covering the rear side of the electronic balance 13.

The windbreak has a ceiling plate 25, a left side plate 26, a right side plate 27, and a front plate 28. The ceiling plate 25 and the front plate 28 are composed of a transparent or semi-transparent acrylic plate to allow the inside of the accommodation box 14 to be seen. The left side plate 26 and the right side plate 27 are made of iron plate. The ceiling plate 25, the left side plate 26, and the right side plate 27 are connected to each other and connected to the accommodation box 14. The right side of the front plate 28 is connected to the front side of the right side plate 27 through a pair of hinges 29 to open and close the front plate 28.

An opening 31 is formed at the center of the ceiling plate 25. The opening 31 is connected to a receiving trough 32 that opens up from the ceiling plate 25. The belt conveyor 11 is disposed to convey the housing H into the receiving trough 32. A rectangular guide trough 33 is disposed below the opening 31 of the ceiling plate 25, and extends vertically in the windbreak to guide the housing H introduced into the receiving trough 32 to a receiving plate 21.

The electronic balance 13 is disposed on a bottom plate of the accommodation box 14 in such a way as to prevent vibration of the floor from being transmitted thereto. A non-defective article-containing box 17 and a defective article-containing box 18 are disposed respectively on the left and right sides of the electronic balance 13. A separation means supplies the weight-inspected housings H to the appropriate box 17, 18 after determining whether the housing H is defective or non-defective.

The electronic balance 13 is an electromagnetic balance and has a measuring base 20 for measuring the weight of the housing H placed thereon. The receiving plate 21 is mounted on the measuring base 20. The periphery of the receiving plate 21 is bent up and its bottom surface is flat and boat-shaped to receive the housing H dropped through the guide trough 33. The receiving plate 21 is supported by parallel left and right arms 22 and 23.

A weight display 13a is provided on the front surface of the electronic balance 13 and indicates the weight of the housing H. The weight display 13a displays the weight of the housing H after the measuring base 20 becomes stable. The weight indicated by the weight display portion 13a is the weight of the housing H after the weight of the receiving plate 21 is excluded, but alternatively may include the weight of the receiving plate 21.

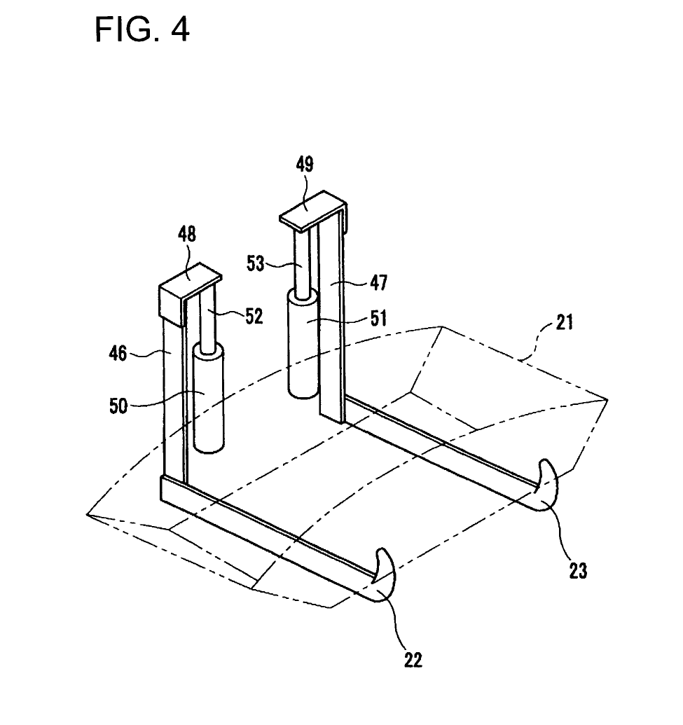

With reference to FIGS. 3 and 4, the left and right arms 22 and 23 can be moved vertically and tilted in the left-to-right direction by an arm-moving/tilting mechanism having left and right plate cylinders 50 and 51 and rods 52 and 53.

The rear ends of the left and right arms 22 and 23 are fixed to the lower end of vertical link plates 46 and 47 respectively. Horizontal link plates 48 and 49 are bonded to the upper ends of the vertical link plates 46 and 47 respectively. The front ends of the rods 52 and 53 of the left and right plate cylinders 50 and 51 are bonded to the horizontal link plates 48 and 49 respectively. The left and right rods 52 and 53 are vertically expandable and contractible.

The left and right plate cylinders 50 and 51 are fixed to the accommodation plate 24 of the accommodation box 14. When the left plate cylinder 50 is turned on, the left rod 52 contracts, and the left arm 22 moves down. On the other hand, when the left plate cylinder 50 is turned off, the left rod 52 expands, and the left arm 22 moves up.

Similarly, when the right plate cylinder 51 is turned on, the right rod 53 contracts, and the right arm 23 moves down. On the other hand, when the right plate cylinder 51 is turned off, the right rod 53 expands, and the right arm 23 moves up.

When the left and right plate cylinders 50 and 51 are operated simultaneously, the left and right arms 22 and 23 are moved down simultaneously to move the receiving plate 21 down. When the left plate cylinder 50 or the right plate cylinder 51 is operated, the left arm 22 or the right arm 23 is disposed at the lower position and the other is disposed at the upper position. In this manner, the receiving plate 21 can be tilted in the right-to-left direction.

Windows 34 and 35 are formed on a lower portion of the left side plate 26 and the right side plate 27 respectively, and sliding bases 36 and 37 are mounted on the left and right windows 34 and 35 respectively. The sliding bases 36 and 37 guide the housing H slideably out from the receiving plate 21 to the non-defective article-containing box 17 or the defective article-containing box 18. The sliding bases 36 and 37 extend down to the outside through the left and right windows 34 and 35 respectively.

A window-opening/closing mechanism is provided on each of the left and right windows 34 and 35. The window-opening/closing mechanism includes left and right shutters 38 and 39, left and right shutter cylinders 40 and 41, and a rod 42 of the shutter cylinder 40 and a rod 43 of the shutter cylinder 41. The left and right shutter cylinders 40 and 41 are supported by brackets 57 and 58 respectively mounted almost horizontally on the front end (upper end) of the expandable rods 42 and 43 respectively. The left and right shutter cylinders 40 and 41 are fixed to the left and right side plates 26 and 27 respectively by means of installing plates 44 and 45. When the left and right shutter cylinders 40 and 41 are turned on, the left and right rods 42 and 43 expand. As a result, the left and right shutters 38 and 39 installed on the front end of the left and right rods 42 and 43 respectively slide up. Thereby the left and right windows 34 and 35 are opened.

When the left and right shutter cylinders 40 and 41 are turned off, the left and right rods 42 and 43 contract. As a result, the left and right shutters 38 and 39 move down and the left and right windows 34 and 35 close.

The separation means functions for separating a non-defective article from an article having a possibility of being defective. The separation means includes the arm-moving/tilting mechanism and the window-opening/closing mechanism. The arm-moving/tilting mechanism and the window-opening/closing mechanism are constructed to coordinate a tilting operation of the receiving plate 21 and an opening/closing operation of the left and right windows 34 and 35 with each other by controlling the operation of a cylinder-driving circuit 68. Thus, the housing H placed on the receiving plate 21 is fed into the non-defective article-containing box 18 or the defective article-containing box 18 by separating the non-defective housing H and the defective one from each other. The control method will be described later.

The left and right shutter cylinders 40 and 41 are turned on and off simultaneously. Thus the left and right windows 34 and 35 are opened simultaneously. However instead of the control method, when the housing H is to be taken out from one of the windows 34 and 35, the shutter cylinders 40 and 41 may be constructed so that only one shutter cylinder 40 or 41 is turned on and the other shutter cylinder 41 or 40 remains off to open only one of the windows 40 and 41.

The control device 16 includes a setting part executing various setting operations and a display part executing various displays. The display part has a pass lamp (not shown) and a failure lamp (not shown). If the weight of the housing H falls within a reference weight that will be described later, the pass lamp is turned on, whereas if the weight of the housing H is out of the reference weight, the failure lamp is turned on.

As shown in FIG. 5, the control part 60 of the control device 16 comprises a microcomputer and has a signal-receiving means 61, a comparison means 62, a determination means 63, and a memory 81.

The signal-receiving means 61 includes a take-out signal-receiving means 61a for receiving a take-out signal and an abnormal signal-receiving means 61b for receiving an abnormal signal.

The take-out signal is outputted from a sensor S1 provided on the injection molding press S. The sensor S1 outputs the take-out signal in response to the completion of an injection molding process. The sensor S1 can be constructed to output the take-out signal when the die 6 is opened or upon completion of the injection process performed by the injection molding press S.

The abnormal signal is outputted when to-be-managed items of the injection molding press S at an injection molding time is out of a predetermined set value. More specifically, the abnormal signal is outputted from a control part S2 of the injection molding press S when a cushioning amount and an injection pressure controlled by the control part S2 are out of the predetermined set value.

The control part 60 controls the operation of the cylinder-driving circuit 68, based on the take-out signal. The cylinder-driving circuit 68 executes on/off control of the operation of the left plate cylinder 50 for vertically moving the left arm 22, the right plate cylinder 51 for vertically moving the right arm 23, the left shutter cylinder 40 for vertically moving the left shutter 38, and the right shutter cylinder 41 for vertically moving the right shutter 39.

The control part 60 includes the comparison means 62 for computing the weight of the housing H placed on the measuring base 20, based on a measurement signal supplied from the measuring base 20 of the electronic balance 13 and comparing the weight of the housing H with the reference weight stored in the memory 81 and the determination means 63 for determining whether the housing H is non-defective or has a possibility that it is defective.

The computed weight and the result of the determination can be displayed on the weight display portion 13a and a display portion of the control device 16 respectively.

It is preferable to use a predetermined absolute reference minimum weight, a predetermined absolute reference maximum weight, and a computed reference weight, which is computed from the weight of the pass signal measured previously.

The weight of the housing H is influenced greatly by environmental factors (temperature and the like) at an operation time. It has been confirmed that data of the weight of the housing H obtained from measurement correlates to a high extent with the change of the number of injection molding times. Thus it is preferable to successively update the computed reference weight in conformity to data of the weight of the housing H, which change with the increase in the number of the measuring times.

The determination means 63 outputs a determination signal to the cylinder-driving circuit 68 to control the arm-moving/tilting mechanism and the window-opening/closing mechanism, both of which function as the separation means. The determination signal includes a pass signal outputted when the housing H is non-defective and a failure signal outputted when the housing H has a possibility of being defective.

When the determination means 63 has outputted the pass signal, the control part 60 executes controls for turning on the left plate cylinder 50, turning off the right plate cylinder 51, and moving only the right arm 23 up to tilt the receiving plate 21 down at the side of the left sliding base 36. Thereafter the control part 60 executes controls for turning on the left and right shutter cylinders 40 and 41 to expand the rods 42 and 43 to slide the left and right shutters 38 and 39 up. Thus, the left and right windows 34 and 35 open, and the housing H on the receiving plate 21 can be dropped to the non-defective article-containing box 17 through the left sliding base 36.

When the determination means 63 has outputted the failure signal, the control part 60 executes controls for turning on the right plate cylinder 51, turning off the left plate cylinder 50, and moving the left arm 22 up to tilt the receiving plate 21 down at the side of the right sliding base 37. Thereafter the control part 60 executes controls for turning on the left and right shutter cylinders 40 and 41 to expand the rods 42 and 43 thereof and slide the left and right shutters 38 and 39 up. Thus the left and right windows 34 and 35 open, and the housing H on the receiving plate 21 can be dropped to the defective article-containing box 18 through the right sliding base 37.

When the control part 60 has received the abnormal signal, the control part 60 outputs to the cylinder-driving circuit 68 a failure signal similar to the above-described failure signal outputted from the determination means 63 (the control part 60 determines that the housing H has a possibility of being defective). Thus, it is possible to execute the control of the separation means, and the control part 60 performs an operation similar to the case in which the determination means 63 determines that the housing H is defective. Accordingly, the housing H placed on the receiving plate 21 can be dropped to the defective article-containing box 18 through the right sliding base 37.

It is known from a close inspection of an actual injection molding operation that when the abnormal signal is received, there is a high possibility that, due to the influence caused by continuation of an abnormal state for some time in the injection molding press S, defective articles will be formed in injection molding operations subsequent to an injection molding operation performed in the abnormal state. Thus, according to the present invention, it is determined that articles formed in the injection molding operations a predetermined number of times after the injection molding operation performed in the abnormal state have a possibility of being defective. As a result, the failure signal is applied to the cylinder-driving circuit 68 to control the separation means for the housings H formed in the injection molding operations a predetermined number of times subsequent to the injection molding operation performed in the abnormal state.

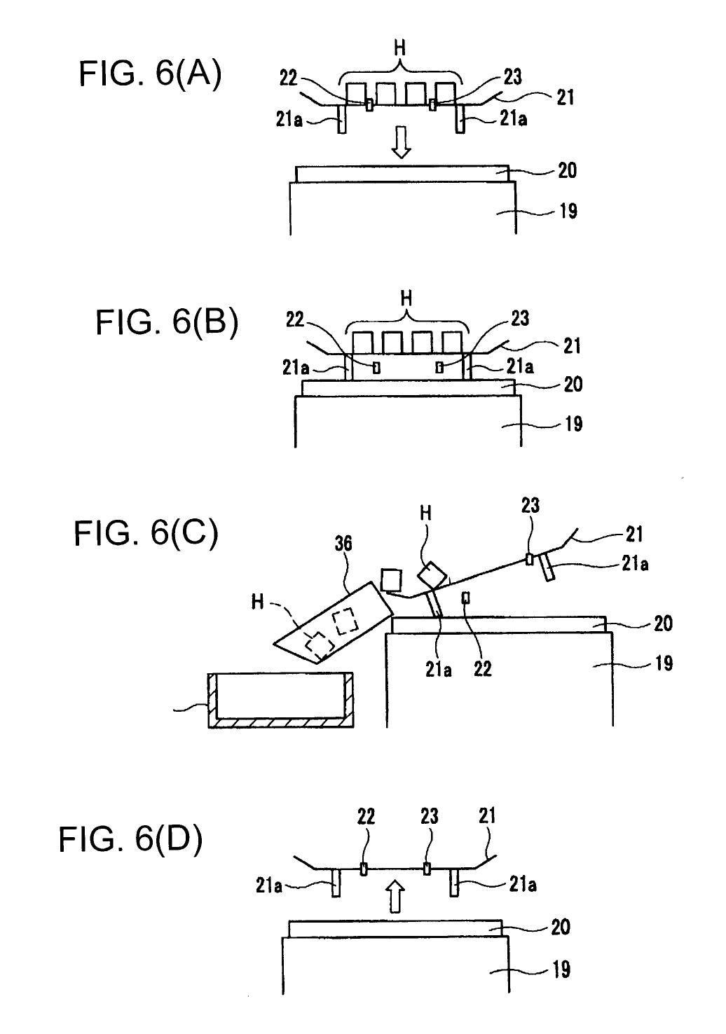

With reference to FIGS. 6 through 8, the operation of the weight inspection apparatus J will be described below.

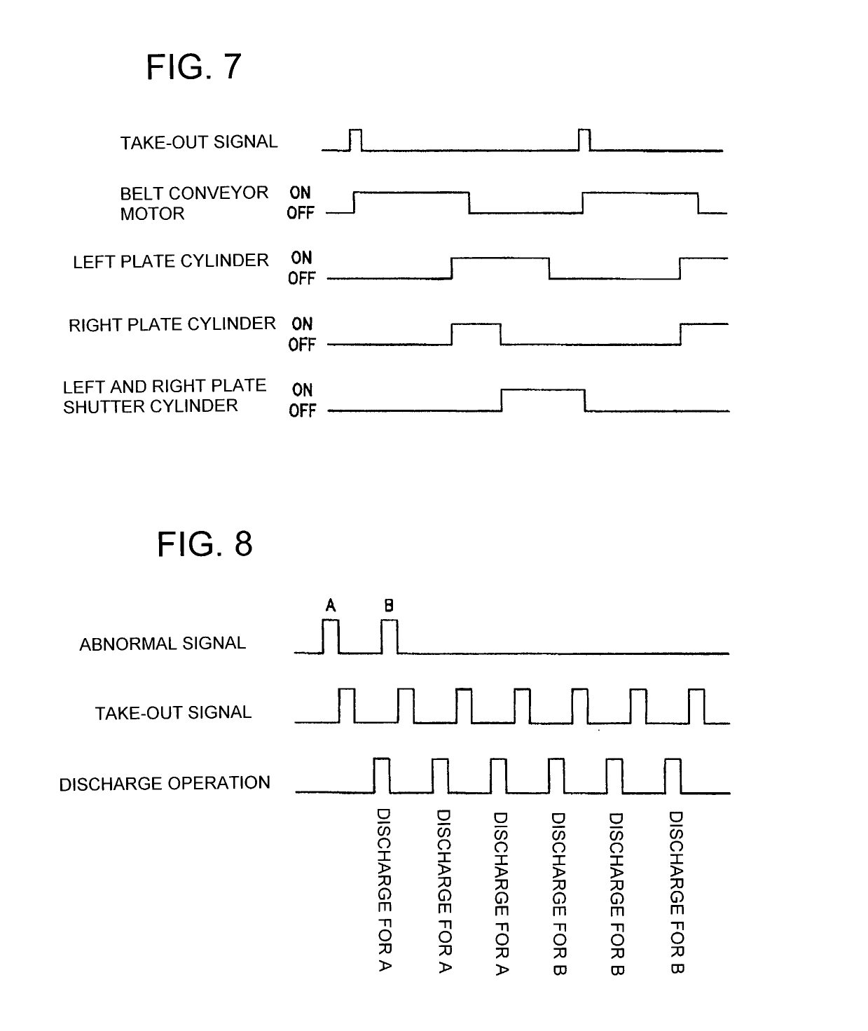

When the injection molding terminates and the die 6 is opened, the take-out signal (pulse signal) is outputted from the sensor S1 to the control part 60 (see FIG. 7), and the housing H that has been hardened in the die 6 drops to a lower portion of the die 6. The housing H is placed on the belt conveyor 11 and fed to the weight-measuring part.

The control part 60 starts a clocking operation upon receipt of the take-out signal from the sensor S1. The control part 60 outputs a signal to the cylinder-driving circuit to turn on the left and right plate cylinders 50 and 51 after a predetermined period of time has elapsed (i.e. the period of time from when the housing H drops to the belt conveyor 11 by opening the die 6 until the time when the housing H drops to the receiving plate 21 after it is fed to the weight-measuring part by the belt conveyor 11).

The left and right arms 22 and 23 are at the upper position, and the receiving plate 21 is above the measuring base 20 when the housing H, whose weight is to be measured, is placed on the receiving plate 21. In this state, the housing H whose weight is to be measured drops to the receiving plate 21 (see FIG. 6A). The left and right arms 22 and 23 then move down slowly, and the receiving plate 21 with the housing H thereon is placed on the measuring base 20. The receiving plate 21 has a leg 21a at each of its four lower corners and the four legs 21a contact the upper surface of the measuring base 20.

The left and right arms 22 and 23 are moved down further to the gap between the receiving plate 21 and the measuring base 20 in such a way that the left and right arms 22 and 23 do not contact either the receiving plate 21 or the measuring base 20. In this state, the electronic balance 13 measures the weight of the housing H (see FIG. 6B).

Thereafter the comparison means 62 compares a measured value of the housing H and the reference weight with each other. If the measured value falls within a predetermined range of the reference weight, the determination means 63 determines that the housing H is non-defective. In this case, the determination means 63 sends the pass signal to the cylinder-driving circuit 68. As a result, only the right plate cylinder 51 is turned off and the left plate cylinder 50 remains on. Thus, the left side of the receiving plate 21 tilts downward. At this time, the left and right shutter cylinders 40 and 41 are turned on, and the left and right shutters 38 and 39 move up, so that the left and right windows 34 and 35 open. As a result, four housings H determined to be non-defective slide down on the left sliding base 36 and drop through the left window 34 to the non-defective article-containing box 17 (see FIG. 6C).

The left plate cylinder 50 is turned off after the required time has elapsed for the four housings H placed on the receiving plate 21 to slide down completely on the left sliding base 36. As a result, the receiving plate 21 becomes horizontal and returns to the original housing-receiving position. The left and right shutter cylinders 40 and 41 are turned off after a certain time has elapsed. As a result, the left and right shutters 38 and 39 move down, and the left and right windows 34 and 35 close (see FIG. 6D).

On the other hand, the determination means 63 sends a failure signal to the cylinder-driving circuit 68 if the control part 60 determines that there is a possibility that the housing H is defective. As a result, only the left plate cylinder 50 is turned off, and the right plate cylinder 51 remains on. Thus the right side of the receiving plate 21 tilts downward. Accordingly, the four housings H slide on the right sliding base 37 and drop through the right window 35 to the defective article-containing box 18.

The right plate cylinder 51 is turned off after the elapse of a period of time required for the four housings H placed on the receiving plate 21 to slide completely down on the right sliding base 37. As a result, the receiving plate 21 becomes horizontal and is returned to the original housing-receiving position. The opening/closing operation of the shutters 38 and 39 is performed similarly to the case in which the housing H is determined as being non-defective.

A cushioning amount or an injection pressure of the injection molding operation may be determined to be out of the predetermined range.

In this case, the die 6 also is opened and the housing H is delivered to the weight-measuring part through the belt conveyor 11.

The abnormal signal is outputted from the control part S2 when the cushioning amount or the injection pressure is less or more than the predetermined value. The abnormal signal is received by the abnormal signal-receiving means 61b of the control part 60 of the weight inspection apparatus J.

Upon receipt of the abnormal signal, the control part 60 outputs the failure signal to the cylinder-driving circuit 68 and performs a clocking operation. At this time, the left plate cylinder 50 is turned off, and the right plate cylinder 51 is turned on. Thus the right side of the receiving plate 21 tilts down, and the comparison means 62 is not operated. The abnormal signal received by the control part 60 is given priority. Thus, the control part 60 turns on the left and right shutter cylinders 40 and 41 to move both shutters 38 and 39 up and to open the left and right windows 34 and 35. Therefore the four housings H delivered by the belt conveyor 11 and placed on the receiving plate 21 slide down on the right sliding base 37, drop through the right window 35 to the defective article-containing box 18, and are discharged forcibly.

The right plate cylinder 51 is turned off after the elapse of a period of time required for the four housings H placed on the receiving plate 21 to slide completely down on the right sliding base 37. As a result, the receiving plate 21 becomes horizontal and returns to the original housing-receiving position. After a certain period of time elapses, the left and right shutter cylinders 40 and 41 are turned off. As a result, the left and right shutters 38 and 39 move down, and the left and right windows 34 and 35 close.

There is a high possibility that the influence that caused the abnormal signal-receiving means 61b of the control part 60 to receive the abnormal signal will continue for some time in the injection molding press S, and that defective housings H will be formed in injection molding operations subsequent to the injection molding operation performed in the abnormal state. Thus, it is determined that all housings H formed in the injection molding operations a predetermined number of times (e. g. three times in the illustrated embodiment) subsequent to the injection molding operation performed in the abnormal state have a possibility of being defective. Accordingly, the housings H determined as being defective are discharged forcibly by an operation similar to that described above.

In the case where the abnormal signals are received successively, an operation of forcibly discharging the housing H is performed accumulatively. That is, as shown in FIG. 8, in the case where two abnormal signals A and B are received successively, a discharge operation is performed six times: 3 (number of times of injection molding operations to be performed for discharge operation in response to one abnormal signal)×2 (number of reception of abnormal signal)=6.

According to the weight inspection apparatus J of the present invention, when the abnormal signal-receiving means has received the abnormal signal, it is determined that the housings H formed in the injection molding operations subsequent to the injection molding operation performed in the abnormal state have a possibility of being defective due to the operation of the weight inspection apparatus performed in association with the operation of the injection molding press. When the abnormal signal-receiving means has received the abnormal signal, the housing H has a high possibility of being defective. Thus the state in which the injection molding press has outputted the abnormal signal is detected to determine that the housing has a possibility of being defective. In this manner, it is possible to determine accurately whether the housing H is defective.

When the abnormal signal-receiving means has received the abnormal signal, it is determined that the housings H formed in the injection molding operations performed a predetermined number of times subsequent to the injection molding operation performed in the abnormal state have a possibility of being defective.

With reference to FIG. 9, two belt conveyors 11 and 11′ are used in combination as the feeding means. It is conceivable that the separation means may cause a timing of determining the housing H as being defective to be delayed. However, in the weight inspection apparatus J′ of the present invention, when the abnormal signal-receiving means has received the abnormal signal, it is determined that housings H formed in the injection molding operations performed at a predetermined number of times subsequent to the injection molding operation performed in the abnormal state have a possibility of being defective. Therefore by providing some number of times in addition to a predetermined number of times, it is possible to prevent non-defective housings H and defective housings H from being present in the same place even though the determination timing is delayed.

In this case, the control part 60 controls the operation of the cylinder-driving circuit 68 appropriately with consideration of a period of time required to feed the housing H by the belt conveyors 11 and 11′. Thus, when the abnormal signal-receiving means 61b has received the abnormal signal, the housing H formed in the injection molding operations performed at a predetermined number of times subsequent to the injection molding operation performed in the abnormal state can be separated from the non-defective article by using the separation means.

Since the weight inspection apparatus has the separation means, it is possible to automatically separate the non-defective housing H from the housing H that have a possibility of being defective. Thus an inspector visually checks a comparatively small number of formed housings H determined as having a possibility of being defective, thus greatly improving operation efficiency.

The present invention is not limited to the above-described embodiments. Needless to say, it is possible to appropriately alter the design of each of the constituent elements unless alterations do not depart from the gist of the present invention.

In the description of the embodiment, as a molded article, the connector housing of a wire harness is inspected. In addition, the present invention can be used to determine whether various resinous articles formed by injection molding are defective or not. According to the present invention, it is possible to use a die providing any number of molded articles.

What is claimed is:

1. A weight inspection apparatus (J) for determining whether an article (H) is defective, the article (H) being formed by injection molding with equipment having a die (6) and an injection molding press (S) that fills a resinous material into said die (6), the article (H) having a weight, the apparatus (J) comprising:
a weight-measuring means (13) for measuring said weight of said article (H) formed in a single injection molding operation performed by said injection molding press (S);
a comparison means (62) for comparing said weight of said article (H) measured by said weight-measuring means (13) with a predetermined reference weight and outputting a difference between said measured weight of said article (H) and said predetermined reference weight;
a determination means (63) for determining that said article (H) is non-defective if said difference outputted from said comparison means (62) falls within a predetermined allowance value and determining that said article (H) has a possibility of being defective if said difference exceeds said predetermined allowance value; and
an abnormal signal-receiving means (61b) for receiving an abnormal signal outputted from said injection molding press (S),
wherein when said abnormal signal is received, it is determined that said article (H) formed in an injection molding operation performed in an abnormal state has a possibility of being defective.

2. The apparatus of claim 1, further comprising a separation means for separating a non-defective article (H) and a defective article (H) from-each other, according to at least one of a result of a determination made by said determination means (63) and a result of a reception of said abnormal signal.

3. The apparatus of claim 2, wherein said abnormal signal-receiving means (61b) functions for determining that articles (H) formed in injection molding operations performed a predetermined number of times subsequent to an injection molding operation performed in an abnormal state have a possibility of being defective.

4. The apparatus of claim 2, wherein when said abnormal signal-receiving means (61b) has received said abnormal signal, the separation means functions for separating an article (H) formed in said injection molding operation performed in an abnormal state.

5. The apparatus of claim 4, wherein said abnormal signal-receiving means functions for receiving an abnormal signal generated from said injection molding press due to at least one of an abnormal cushioning amount and an abnormal injection pressure.

6. A method for detecting defective articles (H) molded by an injection molding press (S), comprising:
measuring at least one parameter of the injection molding press (S) during a mold cycle of the injection molding press (S), said parameter being indicative of at least one abnormality that produces a defective article (H);
comparing the measured parameter with acceptable parameters;
generating an abnormality signal if the measured parameter differs from the accepted parameters;
weighing at least one of the molded articles (H);
comparing the weight to acceptable weights;
generating the weight signal if the weight differs from the acceptable weights;
separating articles (H) produced during one of said mold cycles that generate the abnormality signal.

7. The method of claim 6, wherein the step of measuring at least one parameter comprises measuring a cushioning amount and an injection pressure.

8. The method of claim 6, further comprising separating articles produced during a selected plurality of mold cycles after a mold cycle in which the abnormality signal is generated.
